(19) United States
(12) Patent Application Publication
(10) Pub. No.: US 2026/0339876 A1
(43) Pub. Date: Oct. 29, 2026

(54) PERIPHERAL HARDWARE EMULATION AND SHARING

(71) Applicant: Hewlett Packard Enterprise Development LP, Spring, TX (US)

(72) Inventors: Gary Piccirillo, Cypress, TX (US); Robert L. Noonan, Crystal Lake, IL (US); Timothy Pertuit, Flower Mound, TX (US)

(21) Appl. No.: 19/187,687

(22) Filed: Apr. 23, 2025

(51) Int. Cl. G06F 13/42

(52) U.S. Cl. CPC G06F 13/4282; G06F 2213/0012

(57) ABSTRACT

Data may be received from a computing environment having an associated identifier, the received data corresponding to data output to a serial interface of the computing environment. An accumulator, associated with the computing environment based at least in part on the identifier, that may aggregate data output to the serial interface in the accumulator. The data received from the computing environment may be stored in a memory for later retrieval. Stored data and/or associated data may be provided to the first computing environment.

### BACKGROUND

With the advent of large-scale online services and increasingly large numbers of servers for providing these services, it may be impractical to provide a physical server for every client / customer seeking computing resources. Instead servers and their resources may be virtualized to facilitate sharing, for example, one machine among multiple clients. Each client may be allocated one or more ‘virtual machine’ (VM). Each VM may appear to be an actual machine with a processor, memory, peripherals, etc.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 illustrates a system according to an example implementation.

FIG. 2 illustrates according to one example implementation a method for processing data received from a computing environment, such as data written to a peripheral of the computing device.

FIG. 3 illustrates, according to another example implementation, another method for processing data received from a computing environment, such as data written to a peripheral of the computing device.

FIG. 4 illustrates, according to one example implementation, a system for providing a virtual UART over the PCI-E bus.

FIG. 5 illustrates, in accordance with various example implementations, an example computer device.

FIG. 6 illustrates, according to an example implementation, a storage medium for storing at least instructions to practice aspects of disclosed implementations.

### DESCRIPTION

The following disclosure provides many different examples for implementing different features. Specific examples of components and arrangements are described below to simplify the present disclosure. These are, of course, merely examples and are not intended to be limiting.

The Universal Asynchronous Receiver-Transmitter (UART) is a peripheral providing a communication interface that converts parallel data to serial format for transmission over communication lines. UARTs, such as the 16550, provide serial communication capabilities with features such as configurable baud rates, transmit and receive buffers, and interrupt generation, and many operating systems or hardware initialization environments, such as firmware, BIOS (Basic Input/output System), etc. expect the UART to be present. In virtualized environments, hardware resources may be shared among multiple virtual machines or functions. This sharing is implemented using mechanisms to isolate and manage access to physical hardware while maintaining expected functionality for each virtual entity. As services move to cloud/data centers, server environments, and database providers, thousands of clients or tenants may share computing resources.

VM access to the UART or other peripherals can be a complex issue, particularly when a machine (real or virtual) is expected to provide one. Accessing the UART involves interrupts. Interrupt handling in virtualized environments may involve careful management to route signals to the appropriate virtual function while maintaining performance and preventing resource contention. Peripheral virtualization may be provided using hypervisor emulation, peripheral replication, and/or another suitable solution. With hypervisor emulation, the hypervisor may emulate a device and be invoked on each peripheral access, potentially robbing valuable (and revenue-able) CPU cycles from performing work on client payloads or other tasks. As the number of VMs sharing resources rises, there is a corresponding CPU burden increase that eventually renders further sharing difficult or impractical. Alternatively, another solution is increasing hardware resources. For example, some cloud services duplicate hardware and provide many physical copies of peripherals for sharing between VM instances. But, this approach becomes prohibitively expensive for large-scale environments having many VMs. Eventually, even with replication, physical resources run out and need to be emulated.

Certain implementations of this disclosure include a Virtual UART platform designed to support, for example, "as-a-service" architectures that may be implemented in any of a number of environments, such as cloud/data centers, server environments, database providers, Network Attached Storage, etc. where numerous computing environments, e.g., VMs, containers, or other environments that may access the functionality of a peripheral such as the UART. In the various implementations discussed below, a peripheral may be virtualized for sharing among many different computing environments. To facilitate efficient resource sharing, peripheral virtualization may provide in effect a buffering or a caching mechanism to aggregate communication from many computing environments trying to access a virtualized peripheral. There may be an arbitrary number of buffers, such as physical buffers provided as storage logic and/or circuitry, but in certain implementations there may be fewer buffers than computing environments. The buffers operate to receive data written to the peripheral and, as needed, to efficiently move received data to/from a larger memory storage. The memory storage may be arbitrarily large, but in certain implementations there may be more memory storage than there are buffers, and there could be large enough memory to store peripheral data for all the computing environments.

The buffers may be referred to as accumulators since they are to accumulate data written by a computing environment to a virtual peripheral, and then as appropriate facilitate transfers of the data to memory. For example, a computing environment may be writing to a peripheral serially, and if the data written is small, e.g., a data fragment, it would be inefficient to attempt serial writing data fragments to memory. Instead an accumulator may accumulate data and move a block of data to/from memory as appropriate. A computing environment accessing a virtual peripheral may be referred to as accessing the virtual peripheral by way of a Virtual Function (VF) described in more detail below. As just one example, the virtual peripheral platform may be configured with 4096 Virtual Functions (VFs), 1024 accumulators, and at least as much memory to accommodate each of the VF contexts and data. In one example implementation, the number of VFs and accumulators are adjustable, for example initially starting at 64 VFs and 16 accumulators, and adjusting if and as appropriate. As will be appreciated, adjusting the number of accumulators may include physically increasing the number of accumulators on die and/or logically adding new accumulators by way of, for example, programmable circuitry, see, e.g. FPGAs discussed below. It will be appreciated the storage space allocated per accumulator may vary depending on the type of data being stored. Accumulated data may be streamed to memory, e.g., double data rate (DDR) memory, e.g., in a ring-buffer fashion, when accumulator eviction conditions occur. In one example implementation, there may be a fixed number of accumulators, however, storage associated with each accumulator and other components/circuitry may be dynamically allocated. In one example implementation, there is at least one storage in memory for a VF.

Computing environments may include VMs, containers, or other constructs that used to facilitate sharing computing resources with thousands of clients, customers, or tenants. In the VM context, as one non-limiting example, hardware peripherals could be virtualized with a hypervisor to act as a middleman between a VM instance (or container) and the hardware. However, when there are many (e.g., thousands) VMs, peripheral performance may degrade and hardware acceleration may be appropriate. One solution is expensive: add more physical hardware to distribute the burden. This can prohibitively consume silicon area / on-die space when the virtual peripheral platform is part of a SoC. In the UART example, as VMs or bare metal hypervisor instances are brought up (physically or logically powered-on), boot logs may be viewed and may each be associated with a respective UART. This may be impractical when thousands of VMs are instantiated, such as may be the case when using micro-VMs, containers, and other lightweight environments. In a SoC, due to constrained silicon space, the number of physical UART resources may be balanced with other on-die storage, such as memory buffering writes to a virtualized peripheral, such as a UART, and memory for storing data, such as UART logs. Too many on-die virtual UARTs may decrease available storage space for an individual UART, which may increase the number of transactions to send data to/from a VM; this may reduce performance.

Example implementations may provide a Virtual UART platform presenting a set of UART devices on a peripheral component interconnect express (PCI-E bus using Single Root I/O Virtual (SR-IOV) functionality. SR-IOV may facilitate potentially thousands of VMs to each have what appears to be dedicated UART hardware, while efficiently sharing physical resources by way of virtual functions, efficient memory usage through accumulation before storage, and mechanisms to prevent buffer overflows. In various implementations discussed below, the virtual peripheral platform includes a Tx Manager, Tx Accumulator, TBE (Transmit Buffer Empty) Timer, and Serial Log Extraction capabilities to handle data flow, timing, and stored serial data access.

In some example implementations, the peripheral being virtualized includes a UART, which may be implemented as a two-wire protocol for transmitting and receiving data at a potentially agreed-upon transmission rate. The architecture of computing environments using the virtual peripheral may be environment agnostic. That is, the virtual peripheral architecture may be provided within circuitry, such as a system-on-a-chip (SoC), that transparently presents itself as a conventional UART by way of SR-IOV or other functionality. When the circuitry is embedded in hardware, such as a computer, the hardware simply ‘sees’ a UART. While the following discussion may identify specific use-cases as examples, it will be appreciated the virtual peripheral, and specifically a virtual UART platform, is not reliant on any particular use case.

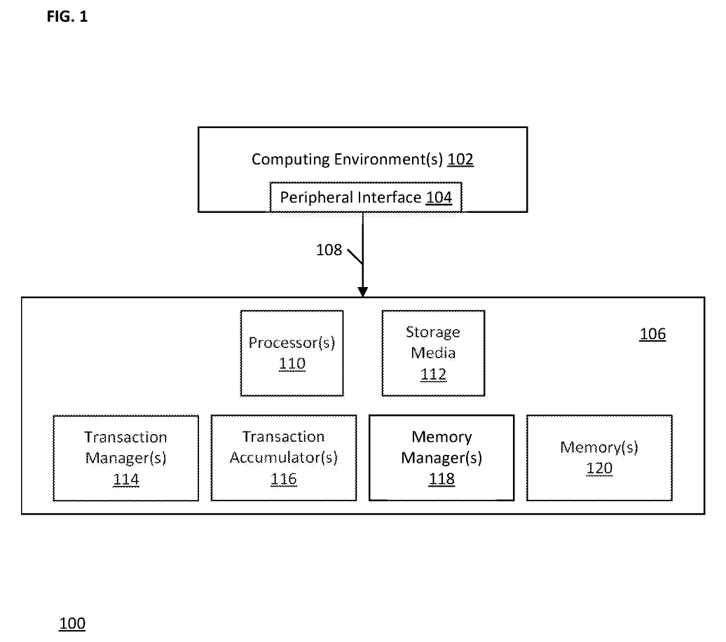

FIG. 1 illustrates a system 100 according to an example implementation. Illustrated is a computing environment 102, which may be a physical machine or a virtual machine having characteristics of a physical machine. The computing environment has an associated peripheral interface 104, which could, as discussed above, be circuitry for a physical peripheral, a virtualized peripheral, or it may be an interface, such as one using a bus interface, to an environment-independent virtual peripheral 106 that appears to be a physical peripheral accessible by the computing environment over a bus 108.

In some example implementations, the environment-independent virtual peripheral 106 includes logic and/or circuitry to present a set of UART devices on a PCI-E bus (or other suitable interface) using the Single Root I/O Virtual (SR-IOV) function / capability. In one example implementation, the virtual peripheral may be implemented entirely in hardware logic and/or circuitry, in another implementation the virtual peripheral may be implemented entirely in software, and in yet another implementation it may be implemented as a combination of hardware logic and/or circuitry and software. For implementations making use of software to aspects of the virtual peripheral, there may be one or more processors 110 and storage media 112 that may cooperatively operate to process, for example, instructions to implement the illustrated transaction manager 114, transaction accumulator 116, and memory manager 118. The illustrated memory 120 may be the same memory as storage media 112, or it may be a different memory for use by the memory manager 118. For the purposes of this discussion, it is assumed the virtual peripheral will be implemented as hardware, such as a SoC, but it will be appreciated by one skilled in the art the disclosed implementations may, as noted above, be implemented in software and/or in combination with hardware.

As will be appreciated any number of peripherals may be virtualized based on the principles disclosed here. The illustrated implementation focuses on virtualizing a UART. It will be appreciated all UART functions may be implemented but for expository convenience, a transmit-only virtual peripheral 106 UART implementation is described, taking an example in which the UART may be used to send data to a log. Logic and/or circuitry provides communication between the bus 108, such as a PCI-E bus, and the transaction manager 114 that provides one or more sets of local UART registers. As will be discussed further below, in one example implementation, some UART registers may be maintained by the transaction manager, and some may be stored in an associated context in memory; the transaction manager may track where specific UART registers are maintained, e.g., locally or in associated memory. The local registers appear to an external environment (e.g., computing environment(s) 102, virtual machines (VMs), micro-VMs, clients, servers, containers, etc.) to be, for example a 16550 UART register set. In an example implementation, a per-environment memory, such as a circular Serial Log Buffer in DDR memory, may store UART Transmit Buffer data. Writes to the peripheral interface 104 corresponding to writing the Transmit Buffer for a conventional UART may be one byte at a time. Since it is inefficient to perform a byte write to memory every time a new request is received, when the transaction manager 114 receives data over the bus 108, it does not directly write to the Serial Log Buffers. Instead, when a write is to be made to the UART Transmit Buffer register (e.g., a 16-byte FIFO), that request is forwarded to a transaction accumulator 116 that handles accesses to the Transmit Buffer for each computing environment 102.

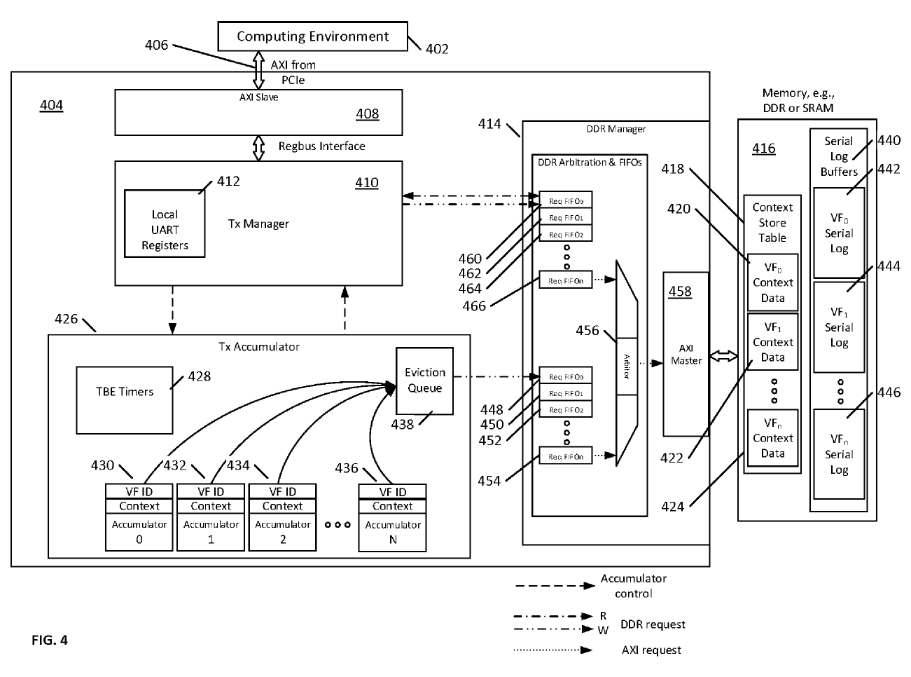

Reference to the transaction accumulator 116 may appear to treat the accumulator as a single storage, as if it is only handling one computing environment 102; however, the operational functionality of the accumulator is to handle receiving and storing (“accumulating”) peripheral data in multiple accumulator memories associated with different computing environments. See, e.g., the FIG. 4 discussion for more detail. In the illustrated implementation, the transaction accumulator may be an arbitrarily sized buffer, e.g., 16-bytes, 32-bytes, etc., and there may be a set number n of accumulators that may accumulate Transmit Buffer data to reduce memory traffic for storing Transmit Buffer data in memory. Certain implementations may use DDR memory for storing data accumulated by the transaction accumulator, but other memory types may be used. It will be appreciated that when implemented in hardware logic and/or circuitry, transaction accumulator silicon area die-cost may be constrained as desired.

For the illustrated implementation, a many:1 correspondence is assumed; that is, there are many computing environments 102 associated with each of the n transaction accumulators 116. It will be appreciated each accumulator may have an associated context. A computing environment accesses its virtual peripheral with a SR-IOV VF or equivalent function, and it is assumed the access function has an identification unique to the computing environment. For example, if the computing environment is a VM or the like, the VM may have an associated ID associated with transactions from that VM accessing its perceived UART, and that associated ID may be referred to as a VF ID. Each accumulator may be associated with a VD ID, allowing potentially immediate storage of virtual peripheral, e.g., UART, Transmit Buffer data for the associated environment. In one example implementation, the VF ID may be determined based at least in part on a PCIe address, or a portion of an address, from which data is received.

Assuming a virtual UART, from a computing environment 102 perspective, the environment uses a VF to write to a UART it perceives to be part of its environment. From the perspective of the virtual peripheral 106, when a Transmit Buffer write is received by the transaction accumulator 116 from the transaction manager 114, the transaction accumulator may check the incoming VF ID to determine if an accumulator has been already been associated with the VF ID. If a match is detected, the data may be stored in the paired accumulator 116. If a match is not detected, an accumulator, if available, may be assigned to store the data from the computing environment. Storage in an accumulator may continue until an eviction condition occurs.

The term “eviction” is used to generally represent conditions that result in data that has been accumulated to be removed from a transaction accumulator 116. Eviction may occur for a variety of reasons. For example, eviction may occur if an accumulator is full, when a Serial Log wrap occurs, if a Serial Log 16-byte boundary cross occurs, when a Max Idle Evict timer expires, when there is no available accumulator for a new write request from a computing environment 102, and/or for any other suitable reason. Upon detection of an eviction condition, content for an evicted accumulator will be written out to memory 120. In certain implementations where some or all of the virtual peripheral is implemented as a SoC, the memory may be on-die to the SoC. In certain implementations, the memory may be in or in combination with system or host memory, with, if and as appropriate, suitable secure access and/or high-speed buses employed to access the system / host memory. As with locating an associated accumulator, on eviction an associated Serial Log buffer is identified or created as appropriate, and the evicted data is stored in the next available location of the associated Serial Log buffer. Serial Logs stored in memory may allow software to extract the contents and the console data may be provided back to the associated computing environment, e.g., a VM that wrote the data out to the peripheral interface 104.

In various implementations, a computing environment 102 may access its UART registers (recall, the virtual peripheral implementation is transparent to the computing environment), through normal register reads, which may be handled by the transaction manager 114. For locally maintained registers, the transaction manager returns current values directly. For registers stored in the computing environment’s context (e.g., a VF context) in memory 120, the transaction manager issues a read request to the memory manager 118 and waits for data to be returned before responding to the computing environment. The illustrated virtual peripheral creates a transparent virtualization layer that allows each computing environment to interact with what appears to be a dedicated peripheral, such as a UART, while efficiently managing the underlying hardware resources and memory bandwidth.

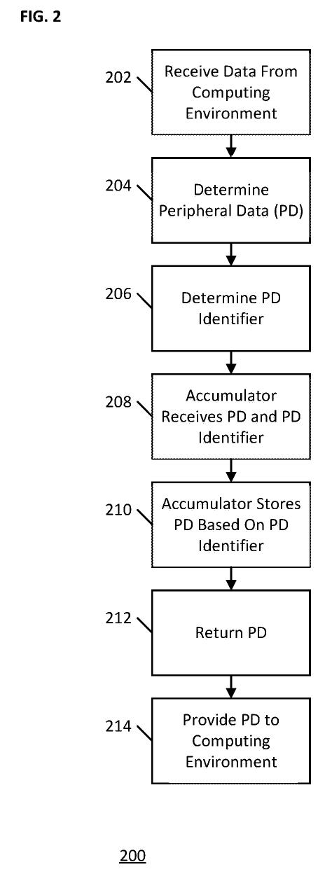

FIG. 2 illustrates according to one example implementation a method for processing data received from a computing environment, such as data written to a peripheral of the computing device. As illustrated, transactions are from the perspective of a transaction manager (Tx Manager). The computing environment communicates with what appears to it to be a UART, but it is communicating with a virtual peripheral capable of emulating at least the transmit functionality of a 16550 UART (virtual UART) capable of working with multiple computing environments. As discussed above, the virtual UART may present on a PCI-E bus using SR-IOV or equivalent functionality. Rather than directly transmitting data serially as in a traditional UART, a virtual UART accumulates transmit data by storing it in a memory, such as a ring-buffer arrangement specific to each virtual function.

In the illustrated implementation, the virtual UART architecture includes a transaction manager that handles incoming 202 data from the PCI-E bus for the computing environment. If we do not assume the data is simply data from a bus request, e.g., we might receive packed data, encrypted data, or data including the peripheral write data along with other data, a next operation would be to determine 204 the peripheral data (PD) written to the virtual UART by the computing environment. The virtual peripheral then determines 206 the PD identifier for the computing environment, e.g., it may be a VM VF ID, that may be used to track to which computing environment the PD belongs. A transaction accumulator receives 208 the PD and PD identifier and maintains buffers for collecting and storing 210 transmit buffer data. In the illustrated implementation, stored peripheral data (PD) may be returned 212 (received back) to the transaction manager, which in turn may provide 214 the PD back to the computing environment. Thus, the dataflow in the illustrated example may be data moving from the computing environment, to the transaction manager, to the transaction accumulator, and back to the transaction manager for return to the computing environment. That may occur when, for example, an accumulator contains the data to be returned to the computing environment and it is not necessary to engage a memory manager as discussed with respect to FIGS. 1, 4. It will be appreciated there may be transactions, data transfers, etc., not illustrated, occurring between operations 210 and 212. That is, data may not be returned to the transaction manager from a transaction accumulator.

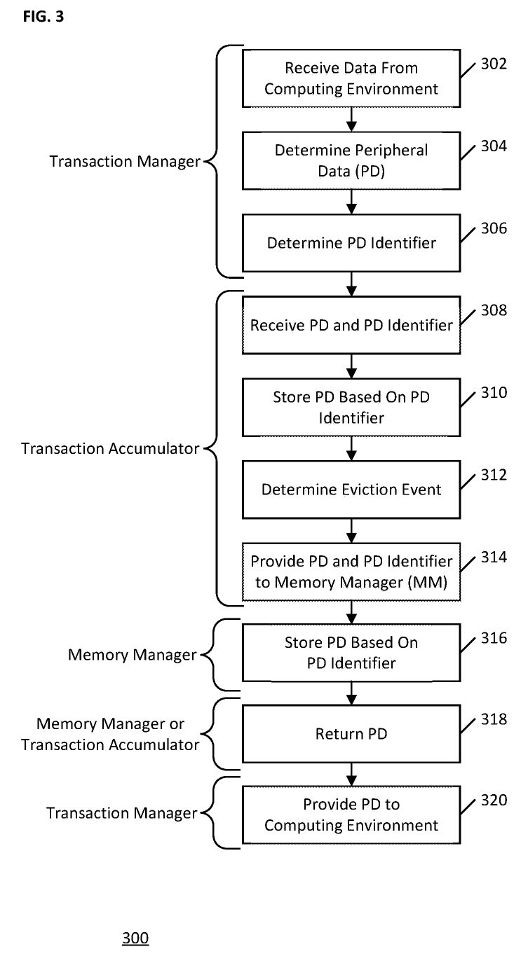

FIG. 3 illustrates, according to another example implementation, a method for processing data received from a computing environment, such as data written to a virtualized peripheral of the computing device. In the illustrated example, operations 302-310 correspond to FIG. 2 operations 202-210, in which as illustrated a transaction manager receives 302 data, determines 304 the PD data, determines 306 the PD identifier, and a transaction accumulator receives 308 the PD and PD identifier, and stores 310 the PD in an accumulator associated with the computing environment based on the PD identifier.

In the illustrated example, the transaction accumulator stores PD data until it determines 312 an eviction event. One skilled in the art will appreciated there are many different reasons one might need to move data out of an accumulator, one common reason being the many:1 relationship of computing environments resulting in there being no accumulator available when a new transaction from a new computing environment has been received by the transaction manager. See FIG. 1 discussion above for more detail on various eviction events. When data needs to be evicted, the transaction accumulator may provide 314 the PD and PD identifier to a memory manager. Note statements using terms such as “provides” is intended to abstract away from a specific protocol or technique for performing an action, e.g., to abstract how to transfer data to/from a memory manager and associated memory.

The memory manager may then store 316 the PD based on, for example, the PD identifier. It will be appreciated that other identifiers and/or criteria may be used to track stored data, but in various implementations, when we know the computing environment, such as a VM, has a unique ID associated with its accessing its virtualized peripheral, that unique ID may be used by the transaction manager, transaction accumulator, memory manager, etc. As discussed above, the memory manager may continue to store data for a computing environment until it is needed. The PD may be returned 318 to the transaction manager to provide 320 the PD to the appropriate computing environment over the bus. In some example implementations, returning the PD may be responsive to a separate request received from the computing environment. In certain implementations, the memory manager could provide the PD to a transaction accumulator (or other virtual peripheral component) to provide to the computing environment, or it may provide the PD to the transaction manager for providing to the computing environment.

FIG. 4 illustrates, according to one example implementation, a system 400 for providing a virtual UART over the PCI-E bus. While the foregoing has been directed to virtualizing peripherals in general, with a UART as one example, this implementation focuses on a virtual UART platform. It should be appreciated, while this illustration shows various components, there may be other logic and/or circuitry not shown that may be part of or work with the virtual peripheral platform.

As illustrated, data flows as discussed above from a computing environment 402 such as a virtual machine, container, computer, etc. to a virtual UART 404 that appears to be a conventional UART to the computing environment. When the computing environment outputs data through a UART, the computing environment may perform a write operation to a specific memory-mapped I/O address that corresponds to the UART's transmit buffer register. In various implementations, the VM accesses what it perceives as a dedicated 16550 UART through a PCI Express (PCI-E) bus interface 406 using SR-IOV (Single Root I/O Virtualization) technology. As will be appreciated by one skilled in the art, SR-IOV allows a single physical PCI-E device to present multiple Virtual Functions (VFs), each appearing as a separate UART device to different computing devices. Computing environments, such as a VM, each see they have a UART. Each VF has a unique identifier (VF ID) distinguishing it from other VFs. As discussed previously, since each computing environment is accessing a unique VF, the unique VF ID may be used to track communication with computing environments.

When a computing environment 402 VM writes a byte of data to the UART Transmit Buffer register, in one implementation, the computing environment executes a write instruction to the memory-mapped address corresponding to the UART Transmit Buffer register and the write request is transmitted over the PCI-E bus 406 with information identifying the specific VF associated with the computing environment. The PCI-E interface routes the request to the virtual UART 404, where it is received by an AXI Slave 408 interface that converts the PCI-E transaction into an internal format. The AXI Slave forwards the request to the Tx Manager 410. In example implementations, the Tx Manager serves as a central coordination point for UART register and/or peripheral data accesses.

When a write request is received from the AXI Slave 408, the Tx Manager 410 examines the request to determine which VF it belongs to, using the VF ID information from the PCI-E transaction. In some implementations, other characteristics of the transaction may be used to identify the correct VF, such as configuration registers or other transaction related data. The Tx Manager determines if the request is a write to the UART Transmit Buffer register or to another UART register. For writes to other UART registers, the Tx Manager may update local UART registers 412, or forward the request to a DDR Manager 414 to update the VF's context stored in memory 440. As illustrated, there is a context store table 418 with an arbitrary number n of UART contexts 420-424 and associated serial log buffers 416 to store UART log data. It will be appreciated that, in some exemplary implementations, n is greater than or equal to the number of VFs.

For writes to the UART Transmit Buffer register, directly sending serial data to memory would be inefficient; instead the Tx Manager 410 sends the VF ID and a byte of data to the Tx Accumulator 426. The Tx Accumulator may then adjust a TBE (Transmit Buffer Empty) Timer 428 to emulate the time it would take to transmit the byte serially. In other implementations the TBE timer is not used. Although some computing environments 402 may be able to accommodate a UART that performs faster than a conventional UART, other computing devices expect a UART to operate at predictable (and predictably slow) speeds. The Tx Accumulator may immediately return a ready signal to the AXI Slave 408 to indicate, from a bus protocol perspective, the write transaction is complete. This allows the computing environment to continue operation without waiting for the data to be stored in an accumulator 430-436 or in memory 416. It will be appreciated the virtual UART has responsibility for storing the data in memory independently of the bus transaction. Although not discussed in detail, it will be appreciated the Tx Manager will, as needed and/or based on features implemented, maintain status bits for each VF, such as the Transmit Buffer Empty status bit, or other statuses as needed, as they may affect interrupt generation and status reporting back to the computing environment to ensure the virtual UART performs as would a physical UART.

In the illustrated implementation, the Tx Accumulator 426 receives the VF ID and data, e.g., a byte of data, from the Tx Manager 410 and accumulates write data before it is written to memory 416. In the illustrated implementation, the Tx Accumulator uses the VF ID to track which computing environment 402 data is currently stored in an accumulator 430-436. The Tx Accumulator may perform a hit/miss check on the VF ID to determine if an accumulator is already assigned to the VF. If a hit occurs (a VF ID match means an accumulator is already assigned to a VF), the byte is stored in the next available position in that accumulator. If a miss occurs, no accumulator has been assigned, and if there is an available accumulator, an available accumulator is selected and assigned to the VF ID. It will be appreciated an accumulator 430-436 may be arbitrarily sized. For purposes of discussion, we can assume each accumulator can store a desired multiple of UART bytes of written data, as well as the VF ID it is associated with, and other context data such as status bits for various conditions (e.g. Accumulator Full, Serial Log Wrap Detect, etc.) and/or other state information.

The Tx Accumulator 426 continues to accumulate written data bytes for a given VF until an eviction conditions occurs. It will be appreciated these are example events and others may be employed as needed/desired. If the accumulator associated with a VF becomes full (all bytes are used), if a Serial Log wrap is detected (the write would reach the end of the circular buffer), if a byte boundary in the Serial Log would be crossed, if an idle timer expires (no new data has been received for a configured period), if an explicit eviction request is received from the Tx Manager 410 (e.g., if no accumulator was are available to be assigned to a new VF ID), or other event of interest to the virtual UART, then an accumulator is evicted. In various implementations, the Tx Accumulator may maintain an indicator, e.g., a pointer, memory marker, etc., to manage the accumulators, such as to identify a next available accumulator for adding new data, a next eviction accumulator to identify an accumulator to write out to memory 416, etc.

When an eviction condition occurs, data from the evicted accumulator 430-436 is transferred to memory 414. In one implementation, the accumulator with the eviction condition may be marked, such as with an Eviction Pending status bit, preventing further data from being stored in it. The associated VF may be signaled to pause writes to the UART. The contents of the accumulator are moved to an eviction queue 438, which holds the data until it can be written to memory. In one implementation, a memory 416 destination address may be calculated, e.g., by the Tx Accumulator 426, and data, e.g. peripheral data, may be stored in an appropriate serial log buffer 440 entry 442-446. In the illustrated example, since the Tx Accumulator 426 may be handling transactions for thousands of computing environments 402, evictions may occur rapidly. To facilitate managing the evictions, the DDR Manager 414 receives this request with the VF ID and places it in an internal FIFO 448-454 to temporarily buffer evictions and facilitate the Tx Accumulator to continue processing other operations without waiting for DDR access to complete. In some implementations, memory bandwidth may be optimized by potentially combining and/or reordering memory requests.

Data to be written to memory may leave the FIFO 448-454 and go to an arbiter 456 to manage access to an AXI (Advanced eXtensible Interface) Master 458. The arbiter may handle data coming into the DDR Manager 414 and data leaving the DDR Manager through FIFOs 460-466. In the illustrated implementation, the arbiter handles data leaving the DDR Manager to be written to memory, and selects between FIFOs 460-466 or FIFOs 449-454, where, e.g., FIFOs 460-466 store context data from a TX Manager that will be written to the context store table 418, and FIFOs 448-454 may store eviction data from the TX Accumulator that may be written to the serial log buffers 440. It will be appreciated the FIFOs 460-466 provide a buffering effect similar to the FIFOs 448-454. The AXI Master may operate as a master side of the AXI protocol to facilitate transactions with DDR memory. It will be appreciated AXI is just one example of a high-performance system bus used in SoC designs and other bus/bus-protocol may be used. The DDR Manager 414 writes data to the appropriate locations in DDR memory, e.g., to the context store table 416 and serial log buffers 440. In one implementation, when the write completes, the DDR Manager may acknowledge the write to the Tx Accumulator. It will be appreciated various status, offset updates, etc. may be performed by the Tx Accumulator 426 and/or the DDR Manager to account for the data written. After eviction, the Tx Accumulator 426 marks the evicted accumulator storage, that is, one of accumulators 430-436, as available for reuse, and the Eviction Pending status bit is cleared. In one implementation, if the DDR Manager 414 determines that a Serial Log for a VF is nearly full and within a predetermined threshold of being full, a Serial Log Full flag may be set to trigger throttling mechanisms to prevent buffer overflow.

In the illustrated example, to return data to a computing environment 402, data stored in DDR memory 414 can be accessed by the computing environment through a Serial Log Extraction process. One such process, which will be referred to as Record Mode, is an implementation of the virtual UART 404 that continuously writes Transmit Buffer contents to the Serial Log in memory and, in contrast to above discussion, does not throttle the host, even if the circular buffer for the Serial Log becomes full. The Serial Log will contain the last “X” number of bytes written to the Transmit Buffer that may be extracted for a computing environment. It will be appreciated the value of “X” is arbitrary and it may be a dynamic value that may change based on systemic/global preferences and/or depending on characteristics of the computing environments and/or on client needs, etc. Another Serial Log Extraction process, which will be referred to as Monitor mode, is an implementation of the virtual UART having a configurable storage log size threshold that may be associated with each computing environment. If an environment’s threshold has been reached, an interrupt may be generated that will notify the software there is data available in a serial log that is ready for extraction. In one implementation, writes to the serial log will continue even if the threshold has been reached. However, in this implementation, no serial log overflow is allowed to occur. When a serial log is almost full, e.g., there would be no more room to store another full accumulator’s data, e.g., from accumulators 430-436, the computing environment may be throttled, e.g., the Virtual UART may set UART status registers to indicate the transmitter is busy to prevent an overflow. In one example implementation, throttling may include blocking or otherwise preventing a Transmit Buffer Empty interrupt from being sent.

The illustrated examples show an accumulator-based design that reduces memory traffic by collecting multiple bytes before storage. The virtual UART 404 can handle thousands of virtual functions for thousands of computing environments 402 with minimal hardware overhead. UART/other virtualized peripheral timing emulation ensures computing environments and their software operate correctly without requiring actual serial transmission. Additionally, as discussed in this illustrated example, the virtual UART provides flexible data extraction modes. In one implementation, there may be 4096 computing environments, each having an VF ID, and each detecting they have a dedicated UART, a Tx Manager 410 distributes UART writes across 1024 Tx Accumulators 430-436, which may be evicted to memory 414 and distributed across 4096 Serial Log Buffers 440-446. The number of accumulators and environments/VF IDs presented are arbitrary and may be adjusted to scale to actual needs. As will be appreciated, scaling may include physically increasing the number of components, such as Accumulators, Serial Log Buffers, or other circuitry on a die, as well as logically adding new components by way of programmable circuitry, see, e.g. FPGAs discussed below and/or dynamically associating memory with die components as desired. Having Serial Logs in memory may allow a larger amount of storage for each external environment instead of a small on die implementation. This may allow larger transfers and increased performance when, for example, console data is moved.

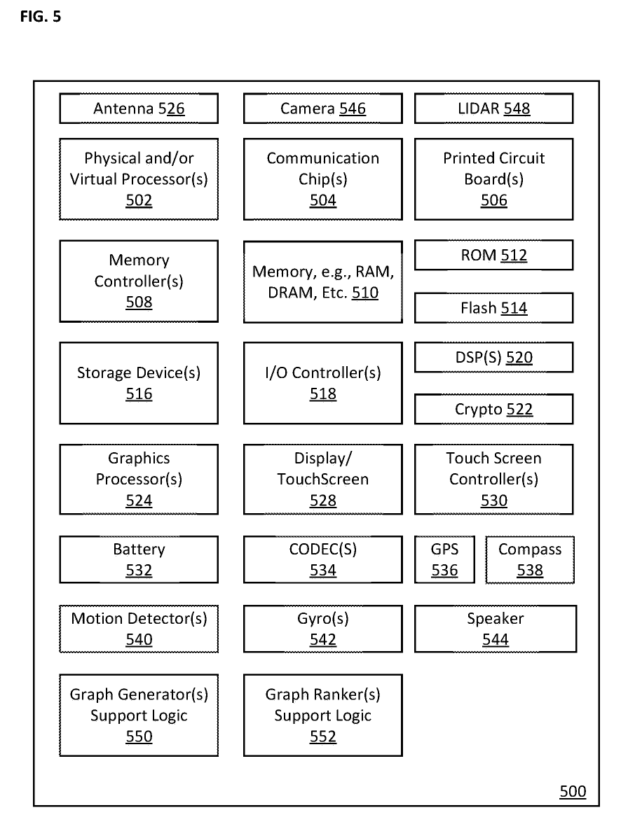

FIG. 5 illustrates, in accordance with various example implementations, an example computer device 500 that may implement and/or support aspects, features, functionality and/or processing of the apparatuses, ‎methods, virtual peripherals and/or other machines described herein for FIGS. 1-4. As shown, computer device 500 (which may be any kind of computing device) may include a number of components, such as one or more processor(s) 502 (one shown) and at least one communication chip(s) 504. In various example implementations, the one or more processor(s) each may include one or more processor cores. It will be appreciated while the term core is used here, other terms may be used such as processing unit(s), execution unit(s) or the like. In various example implementations, the at least one communication chip may be physically and electrically coupled to the one or more processor(s). In further implementations, the communication chip(s) may be part of the one or more processor(s). In various example implementations, computer device 500 may include printed circuit board (PCB) 506. For these example implementations, the one or more processor(s) and communication chip(s) may be disposed thereon. In alternate example implementations, the various components may be coupled without the employment of PCB 506.

Depending on its applications, computer device 500 may include other components that may or may not be physically and electrically coupled to the PCB 506. These other components include, but are not limited to, memory controller 508, volatile memory (e.g., dynamic random access memory (DRAM) 510), non-volatile memory such as read only memory (ROM) 512, flash memory 514, storage device 516 (e.g., a hard-disk drive (HDD)), an I/O controller 518, a digital signal processor 520, a crypto processor 522, a graphics processor 524 (e.g., a graphics processing unit (GPU) or other circuitry for performing graphics, virtual reality (VR) and/or augmented reality (AR)), one or more antenna 526, a display which may be or work in conjunction with a touch screen display 528, a touch screen controller 530, a battery 532, one or more codec(s) 534, e.g., an audio codec, a video codec, a bus management codec, OS policy manager codec, etc., a positioning system such as a global positioning system (GPS) device 536 (it will be appreciated other location technology may be used, including location services provided by software operating within computer device 500 and/or in combination with location estimation services), a compass 538, a motion/movement detector 540, e.g., an accelerometer and/or other devices to detect and/or interpolate motion in one or more axes, real and/or relative movement through space, etc., a gyroscope 542, a speaker 544, a camera 546, a Light Detecting and Ranging (LIDAR) sensor (or other sensing/range detecting and/or measuring technology) 548 and other mass storage devices (such as hard disk drive, a solid state drive, compact disk (CD), digital versatile disk (DVD)) (not shown), and so forth.

As used herein, the term “circuitry” or “circuit” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, processor, microprocessor, programmable gate array (PGA), field programmable gate array (FPGA), digital signal processor (DSP) and/or other suitable components that provide the described functionality. Note while this disclosure may refer to a processor in the singular, this is for expository convenience only, and one skilled in the art will appreciate multiple processors, processors with multiple cores, virtual processors, etc., may be employed to perform the disclosed example implementations.

In some example implementations, the one or more processor(s) 502, flash memory 514, and/or storage device 516 may include associated firmware (not shown) storing programming instructions configured to enable computer device 500, in response to execution of the programming instructions by one or more processor(s), to practice all or selected aspects of the methods described herein. In various example implementations, these aspects may additionally be or alternatively be implemented using hardware separate from the one or more processor(s), flash memory, or storage device(s). In one example implementation, memory, such as flash memory or other memory in the computer device, is or may include a memory device that is a block or byte addressable memory device, such as those based on NAND, NOR, Phase Change Memory (PCM), nanowire memory, and other technologies including future generation nonvolatile devices, or a combination of any of the above, or other memory. The memory device may refer to the die itself and/or to a packaged memory product.

In various example implementations, one or more components of the computer device 500 may implement an example implementation of the FIG. 1 element 106. Thus, for example the one or more processor(s) 502 could be the FIG. 1 processor 110 to implement the FIG. 1 system that may communicate with storage 516 as well as other system components. In some example implementations, I/O controller 518 may interface with one or more external devices to receive a data, such as over a wired and/or wireless bus, including the Universal Serial Bus. Additionally, or alternatively, the external devices may be used to receive a data signal transmitted between components of the computer device 500.

The communication chip(s) 504 may enable wired and/or wireless communications for the transfer of data to and from the computer device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some example implementations they might not. The communication chip(s) may implement any of a number of wireless standards or protocols, including but not limited to mobile broadband (e.g., cellular-based data communication including the following example non-exhaustive list such as IEEE 802.16, IEEE 802.20, LTE/LTE-A, General Packet Radio Service (GPRS), Evolution Data Optimized (Ev-DO), Evolved High Speed Packet Access variants (HSPA+ / HSDPA+ / HSUPA+), GSM, Mobile WiMAX, Digital Enhanced Cordless Telecommunications (DECT)), Bluetooth, derivatives thereof, as well as any other wireless protocols that are designated as providing and/or supporting 3G/4G/5G/xG and beyond. The computer device may include a plurality of communication chips 504. For instance, a first communication chip(s) may be dedicated to shorter range standard or proprietary wireless communications such as Wi-Fi and Bluetooth, and a second communication chip 504 may be dedicated to longer range wireless communications such as GPS, WiMAX, LTE, Ev-DO, and others.

The communication chip(s) may implement any number of standards, protocols, and/or technologies that datacenters may use, such as networking technology providing high-speed low latency communication. For example, the communication chip(s) may support RoCE (Remote Direct Memory Access (RDMA) over Converged Ethernet), which is a routable protocol having efficient data transfers across a network, and is discussed for example at Internet URL RDMAconsortium.com. The chip(s) may support Fibre Channel over Ethernet (FCoE), iWARP, or other high-speed communication technology, see for example the OpenFabrics Enterprise Distribution (OFED™) documentation available at Internet URL OpenFabrics.org. It will be appreciated datacenter environments benefit from highly efficient networks, storage connectivity and scalability, e.g., Storage Area Networks (SANs), parallel computing using RDMA, Internet Wide Area Remote Protocol (iWARP), InfiniBand Architecture (IBA), Omni-Path Architecture (OPA) and other such technology. Computer device 500 may support any of the infrastructures, protocols and technology identified here, and since new high-speed technology is always being implemented, it will be appreciated by one skilled in the art that the computer device is expected to support equivalents currently known or technology implemented in future.

In various implementations, the computer device 500 may be any device implementing virtual peripherals, or be a device into which a virtual peripheral platform is disposed, such as a laptop, a netbook, a notebook, a smartphone, a computer tablet, a personal digital assistant (PDA), an ultra-mobile PC, a mobile phone, a desktop computer, a server, cloud environment, cloud storage, a printer, a scanner, a monitor, a set-top box, an entertainment control unit (e.g., a gaming console, automotive entertainment unit, etc.), a digital camera, an appliance, a portable music player, or a digital video recorder, or a transportation device. It will be appreciated computer device 500 is intended to be any electronic device that processes data.

Although above it is noted the computer device 500 may use the one or more processor(s) 502 to implement the FIG. 1 example implementation, it will be appreciated the computing device may include one or more custom logic, circuitry, chips, etc. such as a system on a chip (SOC), to perform in hardware features and/or functions of the illustrated example implementations. For example, as shown, there may be support logic 550 that may be configured to perform some or all of the operations described above for a FIG. 1 virtual peripheral platform including elements 114-120 or the related structures discussed with respect to FIG. 5. The entirety of the functionality may be implemented, or only a desired subset of functionality may be offloaded for hardware performance benefits for some operations while other operations occur in combination with software that may be accessed from, e.g., storage device 516 or over a network and/or the Internet by way of, for example, communication chip 504 or antenna 526.

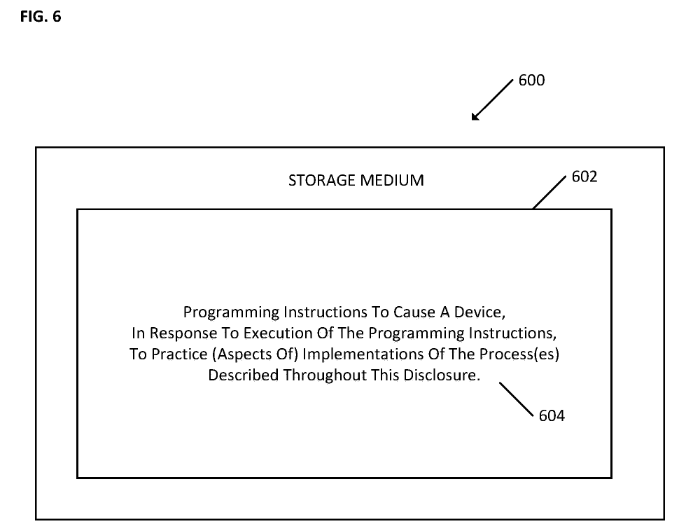

FIG. 6 illustrates an example computer-readable storage medium 600. ‎The storage medium may be transitory, non-transitory or a combination of transitory and non-transitory media, and the medium may be suitable for use to store instructions that cause an apparatus, machine or other device, in response to execution of the instructions by the apparatus, to practice selected aspects of the present disclosure. As will be appreciated by one skilled in the art, the present disclosure may be embodied as methods or computer program products. Accordingly, the present disclosure, in addition to being embodied in hardware as earlier described, may be implemented entirely in software (including firmware, resident software, micro-code, etc.) or by combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

As shown, non-transitory computer-readable storage medium 602 may include a number of programming instructions 604. Programming instructions 604 may be configured to enable a device, e.g., computer device 600, in response to execution of the programming instructions, to implement (aspects of), for example, the FIG. 1 system. In alternate example implementations, programming instructions 604 may be disposed on multiple computer-readable non-transitory storage media 602 instead. In still other example implementations, programming instructions 604 may be disposed on computer-readable transitory storage media 602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). Cooperative program execution may be for a fee based on a commercial transaction, such as a negotiated rate (offer/accept) arrangement, established and/or customary rates, and may include micropayments between device(s) cooperatively executing the program or storing and/or managing associated data.

The present disclosure is described with reference to flowchart illustrations and/or block diagrams of methods, apparatus (systems) and computer program products according to example implementations of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct and/or coordinate operation of one or more computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

While foregoing disclosure was primarily in the context of UART virtualization, it should also be appreciated the techniques disclosed also apply to other serial interface virtualization and data accumulation systems. In particular, aspects of this disclosure may similarly apply to virtualization of other communication interfaces such as the Serial Peripheral Interface (SPI), Inter-Integrated Circuit (I2C), or other serial protocols, such as ones that may be used in embedded systems, telecommunications equipment, or data center applications where multiple virtual environments need to share hardware resources efficiently.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computer system, comprising:
a transaction manager configured to receive data from computing environments, the data including first data outputted to a first interface of a first computing environment identified by a first environment identifier; and
a transaction accumulator with multiple accumulator stores associated with computing environments based at least in part on environment identifiers;
wherein:
the transaction accumulator is configured to receive the first data from the transaction manager, associate the first computing environment with a first accumulator store based at least in part on the first environment identifier, and store the first data in the first accumulator store, and
the transaction manager is further configured to provide second data to corresponding computing environments after storage of the first data in an accumulator store.

2. The computer system of claim 1, wherein the transaction manager is configured to provide the first data to the first computing environment after the transaction accumulator stores the first data in the first accumulator store.

3. The computer system of claim 1, wherein:
the first interface facilitates access to a virtual first Universal Asynchronous Receiver/Transmitter (UART);
the first data includes transmit buffer data for the first UART; and
the first environment identifier is based at least in part on a characteristic of the first UART.

4. The computer system of claim 1, wherein the first interface provides a Single Root I/O Virtual (SR-IOV) functionality.

5. The computer system of claim 4, wherein:
the first computing environment is a virtual machine,
the SR-IOV functionality has a virtual function ID (VF ID), and
the first environment identifier includes the VF ID.

6. The computer system of claim 1, further comprising a first memory configured to:
receive accumulated data evicted from the transaction accumulator, and
provide access to the evicted data to a selected one or more of the transaction manager or the first computing environment.

7. The computer system of claim 6, further comprising:
a memory manager communicatively coupled to the transaction manager, the transaction accumulator, and the first memory;
wherein the memory manager is configured to
receive an evicted data from the transaction accumulator,
provide the evicted data for storing in the first memory, and
receive a stored data from the first memory.

8. The computer system of claim 7 wherein the memory manager is further configured with input/output buffers to temporarily buffer receiving data and sending data.

9. A method, comprising:
receiving first data from a first computing environment having a first environment identifier, the first data corresponding to data output to a serial interface of the first computing environment;
associating a first accumulator with the first computing environment based at least in part on the first environment identifier;
aggregating data output to the serial interface in the first accumulator; and
providing second data corresponding to the first data to the first computing environment.

10. The method of claim 9, wherein
a transaction accumulator provides the first accumulator, and
a selected one of a transaction manager or the transaction accumulator provides the first data to the first computing environment.

11. The method of claim 9, further comprising:
determining an eviction condition for the first accumulator;
evicting data from the first accumulator; and
storing the data evicted from the first accumulator in a first memory associated with the first accumulator.

12. The method of claim 11, wherein
a transaction accumulator receives the first data; and
a memory manager receives data evicted from the transaction accumulator, stores the data evicted from the transaction accumulator in the first memory, and retrieves stored evicted data.

13. The method of claim 9, wherein the serial interface provides a Single Root I/O Virtual (SR-IOV) functionality.

14. A computer system, comprising:
one or more processors; and
one or more non-transitory computer-readable storage media storing programming for execution by the one or more processors, the programming comprising instructions to:
receive first data from a first computing environment identified by a first environment identifier, the first data corresponding to data output to a serial interface of the first computing environment;
associate a first accumulator with the first computing environment based at least in part on the first environment identifier;
aggregate data output to the serial interface in the first accumulator; and
provide second data to the first computing environment.

15. The computer system of claim 14, wherein:
a transaction accumulator is to provide the first accumulator, and
a selected one of a transaction manager or the transaction accumulator is to provide the first data to the first computing environment.

16. The computer system of claim 14, wherein the programming further comprises instructions to:
determine an eviction condition for the first accumulator;
evict data from the first accumulator; and
store evicted data in a first memory associated with the first accumulator.

17. The computer system of claim 16, wherein:
a transaction accumulator is to receive the first data; and
a memory manager is to receive evicted data from the transaction accumulator, store evicted data in the first memory, and retrieve stored evicted data.

18. The computer system of claim 14, wherein the serial interface provides a Single Root I/O Virtual (SR-IOV) functionality.

19. The computer system of claim 18, wherein
the computing environment is a virtual machine,
the SR-IOV functionality has a virtual function ID (VF ID), and
the first environment identifier includes the VF ID.

20. The computer system of claim 19, wherein the serial interface corresponds to a UART.
